(19) United States
(12) Patent Application Publication
(10) Pub. No.: US 2017/0279994 A1
(43) Pub. Date: Sep. 28, 2017

(54) CONTROL DEVICE FOR USER AUTHENTICATION, IMAGE PROCESSING APPARATUS, IMAGE PROCESSING METHOD, INFORMATION PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Akihide Oshima, Kanagawa (JP)

(21) Appl. No.: 15/214,571

(22) Filed: Jul. 20, 2016

(30) Foreign Application Priority Data
Mar. 23, 2016 (JP) 2016-058448

(51) Int. Cl. H04N 1/00; G06F 3/12; H04L 29/08; H04L 29/06; H04W 4/00

(52) U.S. Cl. CPC H04N 1/00854; H04L 67/42; H04W 4/008; H04L 67/146; H04N 1/00875; G06F 3/1292; G06F 3/1288; G06F 3/1222; G06F 3/1238; H04W 88/02

(57) ABSTRACT

A control device includes a wireless communication section, a detection section that detects a user's approach, an acquisition section that acquires authentication information and authority information regarding a user of a terminal when receiving a request from the terminal by the wireless communication section, and a control section that controls a processing section of an information processing apparatus so that a function corresponding to the acquired authority information is realized when the approach of the user of the terminal is detected by the detection section.

### CROSS-REFERENCE TO RELATED APPLICATIONS

This application is based on and claims priority under 35 USC 119 from Japanese Patent Application No. 2016-058448 filed on Mar. 23, 2016.

### BACKGROUND

### TECHNICAL FIELD

The present invention relates to a technique using an information processing apparatus by using a portable terminal.

### SUMMARY

According to an aspect of the invention, there is provided a control device including a wireless communication section, a detection section that detects a user's approach, an acquisition section that acquires authentication information and authority information regarding a user of a terminal when receiving a request from the terminal by the wireless communication section, and a control section that controls a processing section of an information processing apparatus so that a function corresponding to the acquired authority information is realized when the approach of the user of the terminal is detected by the detection section.

### BRIEF DESCRIPTION OF THE DRAWINGS

Exemplary embodiments of the present invention will be described in detail based on the following figures, wherein:

FIG. 1 is a diagram showing an outline of an information processing system;

FIG. 2 is a diagram showing a functional configuration of an image forming apparatus;

FIG. 3 is a diagram showing a functional configuration of an authentication server;

FIG. 4 is a diagram showing a functional configuration of a portable terminal; and

FIG. 5 is a diagram showing the operation of the information processing system.

### DETAILED DESCRIPTION

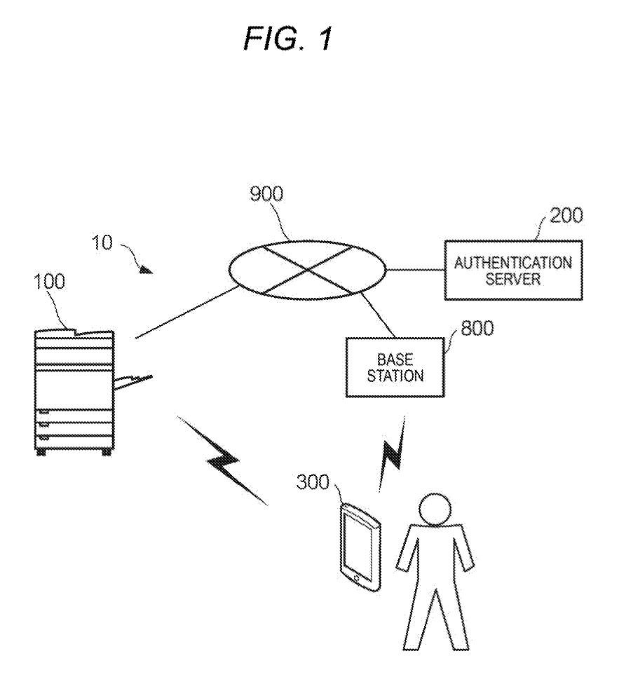

FIG. 1 shows an outline of an information processing system 10. The information processing system 10 includes an image forming apparatus 100, an authentication server 200, and a portable terminal 300. Meanwhile, only one image forming apparatus 100 is shown in the drawing, but plural image forming apparatuses 100 capable of being used from one portable terminal 300 may be present.

The portable terminal 300, which is a wireless communication terminal device carried by a user, is an information electronic device for consumer's use such as a tablet computer or a smart phone. The image forming apparatus 100 is an image forming apparatus, such as a printer, a scanner, a facsimile, and the transmission and reception of an e-mail, which has functions related to image formation or the transmission and reception of image data. The portable terminal 300 is an authentication server having a database that stores information regarding a user who permits the use of the image forming apparatus 100. The image forming apparatus 100 and the authentication server 200 are connected to each other through a network 900. The network 900 is the Internet or an intracompany LAN. The portable terminal 300 and the authentication server 200 are connected to each other through the base station 800 and the network 900.

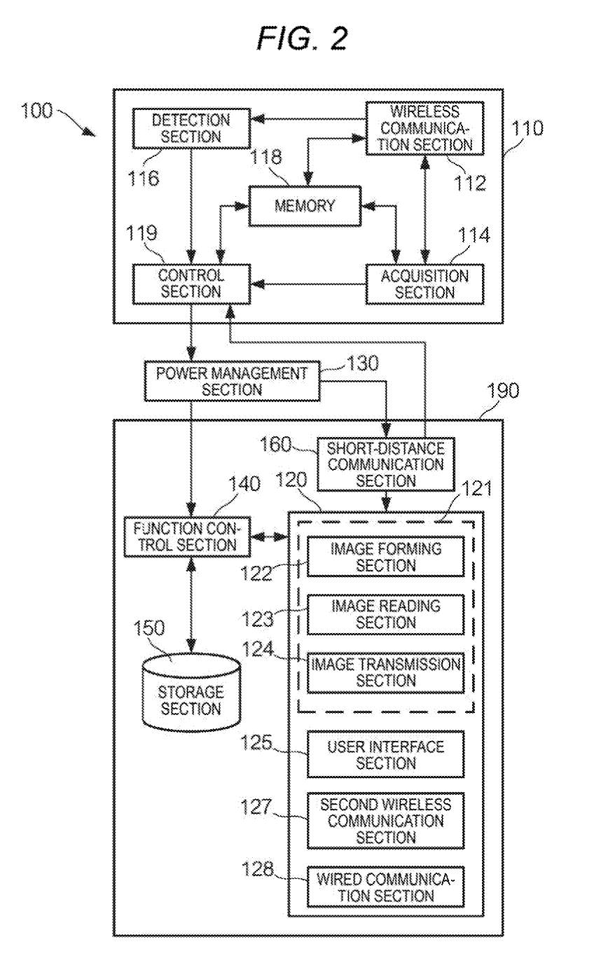

FIG. 2 shows a functional configuration of the image forming apparatus 100. The image forming apparatus 100 includes a communication unit 110, a power management section 130, and an information processing unit 190. The communication unit 110 functions as a control device that communicates with the portable terminal 300 to perform user authentication and controls the information processing unit 190 on the basis of an authentication result. The information processing unit 190 is an assembly of functions related to image formation which operates while being supplied with predetermined power. The power management section 130 controls the supply of power (start or termination) to the information processing unit 190.

During the operation of the image forming apparatus 100, power is supplied to the communication unit 110 and the power management section 130 at all times from a power supply not shown in the drawing, and thus the communication unit 110 and the power management section 130 continuously operate. On the other hand, power is supplied to the information processing unit 190 as necessary. In other words, a function of the communication unit 110 is maintained at all times, but at least a portion of the information processing unit 190 is not limited to functioning at all times. This is for the purpose of suppressing power consumption in the image forming apparatus 100 by stopping at least a portion of the functions of the information processing unit 190 in a case where it is not necessary to execute processing. Hereinafter, a state where all of the functions of the information processing unit 190 are stopped and the image forming apparatus 100 operates with first power is referred to as a low power consumption mode, and a state where at least a portion of the information processing unit 190 functions and the image forming apparatus 100 operates with second power greater than the first power is referred to as a high power consumption mode. Meanwhile, in the high power consumption mode, it is possible to set power consumption in a stepwise manner by setting a functional unit to be operated.

The communication unit 110 includes a wireless communication section 112, an acquisition section 114, a detection section 116, a memory 118, and a control section 119. The communication unit 110 is implemented as a wireless transmission and reception unit according to, for example, Bluetooth (registered trademark) Low Energy (BLE) standard or the like.

The wireless communication section 112 is a transmission and reception module including an antenna and a signal processing circuit. In addition to information required to perform wireless communication with the portable terminal 300, the wireless communication section 112 transmits and receives information, such as a user ID and a password, which are used to perform user authentication and information regarding the approach of the portable terminal 300 to and from the portable terminal 300. Specifically, the wireless communication section intermittently broadcasts a beacon included in identification information of the communication unit 110 from the wireless communication section 112, and receives information including an identifier of the portable terminal 300, which is transmitted from the portable terminal 300 responding to the beacon, in a wireless manner. Information necessary for authentication and authority information indicating a user's authority regarding the use of the image forming apparatus 100 are output to the acquisition section 114. On the other hand, a signal regarding the approach of the portable terminal 300 is output to the detection section 116.

The memory 118, which is a memory module such as a nonvolatile memory, stores information to be transmitted to the portable terminal 300 which is required to perform wireless communication with Me portable terminal 300 and information which is received from the portable terminal 300 or the authentication server 200. Meanwhile, information stored in the memory 118 is transmitted to a storable section 150 when a function control section 140 and the storage section 150 operate, and thus stored contents of the memory 118 and the storage section 150 are synchronized with each other.

The acquisition section 114, which is implemented as a processor, transmits information (address information which is necessary for the portable terminal 300 to have access to the authentication server 200, or the like) which is required to perform an authentication process through the wireless communication section 112 to the portable terminal 300, and outputs authentication information received from the portable terminal 300 to the control section 119. When the acquisition section 114 acquires authentication information, indicating an authentication result with respect to a user of the portable terminal, which is generated by the authentication server 200 and authority information of the user, the acquisition section outputs the acquired pieces of information to the control section 119. The authority information refers to information for designating one or more functions (for example, only printing) which are capable of being used by the user among the functions (for example printing, copying, and scanning) of the image forming apparatus 100.

The detection section 116, which is implemented as a processor, calculates a distance from the portable terminal 300 on the basis of signal intensity, received, and determines that a user of the portable terminal 300 has approached the image forming apparatus 100 when the signal intensity falls below a threshold value. Similarly, even in a case where a predetermined command transmitted in relation to the degree of approach from the portable terminal 300, it is determined that the user of the portable terminal 300 has approached the image forming apparatus 100. A determination result is output to the control section 119.

The control section 119, which is implemented as a processor, controls the information processing unit 190 so that a function corresponding to authority information of the user is realized by the image forming apparatus 100 when the approach of the user of the portable terminal 300 is detected. Specifically, the control section 119 specifies one or more functional modules within the information processing unit 190 corresponding to authority information supplied from the acquisition section 114 on the basis of the authority information, and stops supplying power to at least one or more functional modules among the specified one or more functional modules, until at least the user's approach is detected. The control of power is performed by outputting a control signal to the power management section 130.

The control section 119 starts processing performed by the specified one or more functional modules when a user is detected. Specifically, the control section 119 makes the power management section 130 supply power to the function control section 140, and then outputs a control signal to the function control section 140. In addition, a control signal is output to the function control section 140 so that data to be processed, which is acquired in advance, is processed using the specified one or more functional modules.

A method of acquiring data to be processed is as follows. First, the control section 119 generates setting information (for example, information for designating a communication method in a case where the function is accompanied by communication with the portable terminal 300) for realizing a function corresponding to acquired authority information by the image forming apparatus 100, and transmits the generated setting information to the portable terminal 300 through the wireless communication section 112. Information for designating processing (for example, image data to be processed, conditions and parameters related to image formation, or the like) which is transmitted in accordance with the setting information is acquired from the portable terminal 300 through a second wireless communication section 127. The acquired information is stored in the memory 118 (and the storage section 150 after the function control section 140 operates).

In addition, the control section 119 includes a timer, and measures an elapsed time since the generation and acquisition of authentication information. Meanwhile, the acquisition section 114, the detection section 116, and the control section 119 may be implemented as one processor, or may be implemented as individual processor modules.

The power management section 130, which is a processor for controlling a power supply, performs the supply of power to each section (a function control section 140 is also included) of the information processing unit 190 by receiving a control signal from the control section 119 to make the each section transition to a high power consumption mode. At this time, the power management section 130 can independently select whether to supply power to each section of the information processing unit 190 (in other words, whether to validate or invalidate each functional module).

For example, in a case where a function supplied from the control section 119 is a function for designating printing, power is supplied to only the function control section 140, an image forming section 122, and a user interface section 125 which are necessary for a printing function. However, in a case where an operation such as the input or confirmation of printing conditions is not necessary, power may be supplied to only the function control section 140 and the image forming section 122. On the other hand, in a case where copying is designated as a function, power is supplied to an image processing unit 121, the image forming section 122, an image reading section 123, and the user interface section 125.

In addition, the power management section 130 controls the stop of power supply to the information processing unit 190 on the basis of a control signal from the function control section 140. Specifically, in a high power consumption mode, the function control section 140 monitors an operational state of each section of the information processing unit 190.

In a case where a predetermined condition (for example, a condition in which an input through the user interface section 125 is not performed for a predetermined period of time, a condition in which an input through a short-distance communication section 160, a second wireless communication section 127, and a wired communication section 128 is not performed, or the like) is satisfied, a control signal is output to the power management section 130, and the power management section 130 stops the supply of power to each section of the information processing unit 190 to thereby perform transition to a low power consumption mode. For example, in a case where an input to the user interface section 125 is not performed for a predetermined period of time, the supply of power to the user interface section 125 and the image processing unit 121 is stopped.

The information processing unit 190 includes a functional unit 120, a power management section 130, a function control section 140, a storage section 150, and the short-distance communication section 160.

The functional unit 120, which is a functional module group for realizing functions of the image fanning apparatus 100, includes the image processing unit 121, the user interface section 125, the second wireless communication section 127, and the wired communication section 128.

The image processing unit 121, which is a functional module related to image formation and the transmission and reception of image data, includes the image forming section 122, the image reading section 123, and an image transmission section 124. The image forming section 122, which is implemented as hardware such as an image processor, a developing device, a developer (toner), a charging device, a light source, an optical system, a recording medium (paper), a photosensitive drum, or a paper transport mechanism, is a functional unit for forming an image on a recording medium on the basis of image data by an electrophotographic method.

The image reading section 123, which is implemented as an image sensor or an image processor, is a functional unit for generating image data by optically reading an image formed on a medium.

The image transmission section 124, which is implemented as a communication interface or a signal processor, is a functional unit for transmitting and receiving image data read by the image reading section 123 or image data generated by the image forming section 122 to and from another device through a network, transmitting the image data as facsimile data through a telephone line, and transmitting and receiving the image data as e-mail data.

The user interface section 125 is a functional unit for displaying information regarding processing such as image, formation or the transmission and reception of image data and for receiving an instruction related to image formation or the transmission and reception of an image from a user, and is implemented as, for example, a touch panel.

The second wireless communication section 127, which is implemented as an antenna or a signal processing circuit, transmits and receives information to and from the portable terminal 300 in accordance with the wireless communication standard such as WiFi (registered trademark), WiFi-Direct, or Bluetooth (registered trademark). Specifically, the second wireless communication section 127 transmits setting information (a method of transmitting data which is a target for image formation or parameters for performing the transmission (for example, a mac address and an encryption key of the second wireless communication section 127, and the like)) which is necessary for image formation to the portable terminal 300, and receives information (image data to be processed, parameters used for image formation, and the like) for designating contents of image processing from the portable terminal 300. However, in a case where transmission and reception to and from the portable terminal 300 are performed in order to acquire information regarding user authentication and authority information, transmission and reception are performed through only the wireless communication section 112. The second wireless communication section 127 operates while being supplied with power greater than that of the wireless communication section 112.

The wired communication section 128, which is a wired LAN interface, transmits and receives information to and from the authentication server 200. Specifically, the wired communication section has access to the authentication server 200 to request a user's authentication, and receives an authentication result.

The short-distance communication section 160, which is implemented as a short-distance wireless communication module based on a standard such as near field communication (NFC), transmits or receives information to or from the portable terminal 300. Specifically, a user brings the portable terminal 300 into close to a short-distance wireless communication module built in the image forming apparatus 100, for example, up to a distance equal to or less than several centimeters to thereby input information, such as a predetermined command or data to be processed, to the image forming apparatus 100. A signal indicating that an input of information is performed through the short-distance communication section 160 is output to the control section 119.

The storage section 150, which is a storage device such as a semiconductor memory or a hard disk, stores identification information of a user, identification information of the portable terminal 300, and authority information of the user which are supplied from the communication unit 110 in association with each other, in addition to a control program for realizing the operation (details will be described later) of the image forming apparatus 100. In addition, information to be subjected to processing (image data to be printed, or the like) regarding the user's instruction, which is executed in the image processing unit 121, may be stored. Meanwhile, authentication information is deleted when a predetermined condition (a case where processing is completed or a case where a predetermined period of time elapses from the generation of authentication information) is satisfied. Thereby, the number of portable terminals 300 that permit the use of the image forming apparatus 100 is appropriately maintained.

The function control section 140, which is a processor such as a CPU, controls all of the operations of the information processing unit 190 other than the control of power. Meanwhile, the function control section 140 may operate a portion of the operations in accordance with functional information supplied from the control section 119. For example, the function control section 140, which is implemented as plural modules taking charge of the control of the sections of the functional unit 120, operates only a portion taking charge of the control of a function corresponding to the image processing unit 121 and stops the other portions. In short, a function designated by the control section 119 may be realized in the image forming apparatus 100, and minimum power required may be supplied to the information processing unit 190 at that time.

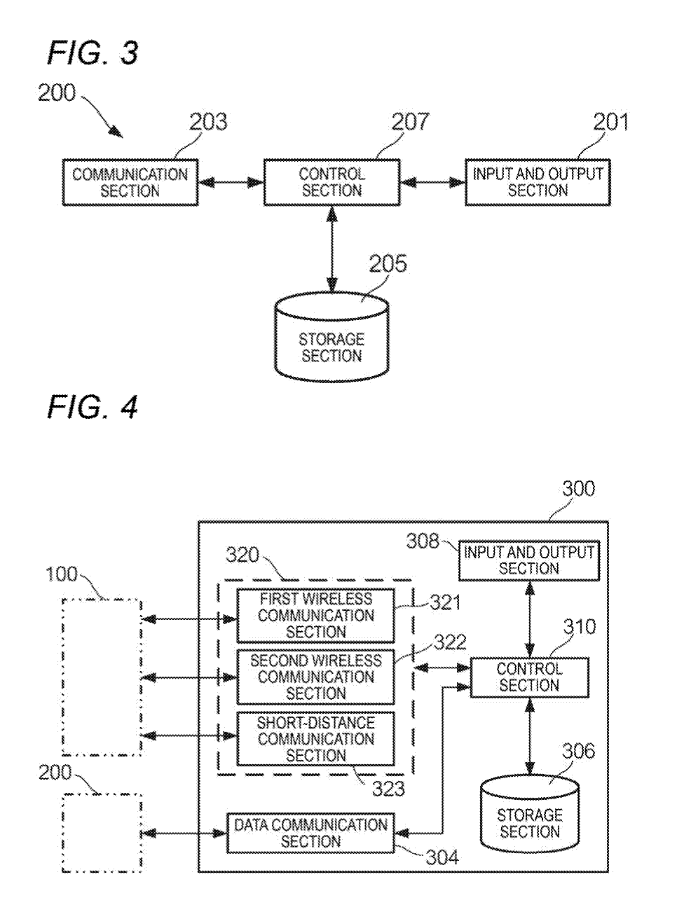

FIG. 3 shows a functional configuration of the authentication server 200. The authentication server 200 includes a communication section 203, an input and output section 201, a storage section 205, and a control section 207.

The storage section 205, which is a hard disk or a semiconductor memory, stores a database in which an identifier of a user and authority information regarding the user's permission or non-permission of use of the image forming apparatus 100 are registered. In addition, information regarding a use condition (validated date or the like) of the image forming apparatus 100 may be further stored in the database.

The input and output section 201 such as a keyboard or a display, is used when a manager of the authentication server 200 inputs and outputs information. The communication section 203, which is a LAN interface, generates and transmits authentication information indicating an authentication result and authority information with reference to a database to the portable terminal 300 when receiving a request for user authentication from the authentication server 200 or the portable terminal 300 through the base station 800.

FIG. 4 shows a functional configuration of the portable terminal 300. The portable terminal 300 includes a wireless communication unit 320, a data communication section 304, an input and output section 308, a storage section 306, and a control section 310. The wireless communication unit 320 includes a first wireless communication section 321, a second wireless communication section 322, and a short-distance communication section 323.

The first wireless communication section 321 is implemented as a module that performs wireless communication with the wireless communication section 112 in accordance with a standard such as BLE. Specifically, the first wireless communication section receives a beacon transmitted from the communication unit 110 and transmits information necessary for authentication (may include at least a user ID in addition to a password). In addition, the first wireless communication section 321 may calculate information indicating the degree of approach between the image forming apparatus 100 and the portable terminal 300, and may transmit a command for commanding the image forming apparatus 100 to validate a function on the basis of the information to the wireless communication section 112. For example, the first wireless communication section 321 calculates a distance to the image forming apparatus 100 on the basis of signal intensity (RSSI) received from the image forming apparatus 100, and transmits a signal indicating that the distance is set to be equal to or less than a threshold value.

The second wireless communication section 322 transmits and receives information to and from the second wireless communication section 127 in accordance with a wireless communication standard such as WiFi (registered trademark), WiFi-Direct, or Bluetooth (registered trademark) Classic. The short-distance communication section 323, which is implemented as a short-distance wireless communication module based on a standard such as near field communication (NFC), transmits and receives information to and from the short-distance communication section 160. The data communication section 304 is a communication module for transmitting and receiving information to and from the authentication server 200 through the network 900 in accordance with a wireless communication standard such as 3G or LTE.

The input and output section 308, which is a touch panel or the like, is used to input information such as a user identifier which is required to perform authentication by the authentication server 200.

The storage section 306, which is a nonvolatile semiconductor memory, stores an application program, operating on an OS, for causing the image forming apparatus 100 to realize an operation to be described later in order to use the image forming apparatus 100 using the portable terminal 300, in addition to an OS, as an information processing terminal, for basically realizing a function. In addition to information (an apparatus identifier of the portable terminal 300 or the image forming apparatus 100 which is a communication party, a key in a case where encryption communication is performed, or the like) which is required to perform communication with the image forming apparatus 100, data such as image data which is used for processing using the image forming apparatus 100 is stored.

Meanwhile, the information necessary for authentication may be stored in the input and output section 308 in advance and may be read out whenever the image forming apparatus 100 is accessed, instead of being input from the storage section 306 whenever the image forming apparatus 100 is accessed.

The control section 310, which is a processor that executes an application program to thereby cause the portable terminal 300 to realize a function to be described later, controls the wireless communication unit 320, the data communication section 304, the input and output section 308, and the storage section 306.

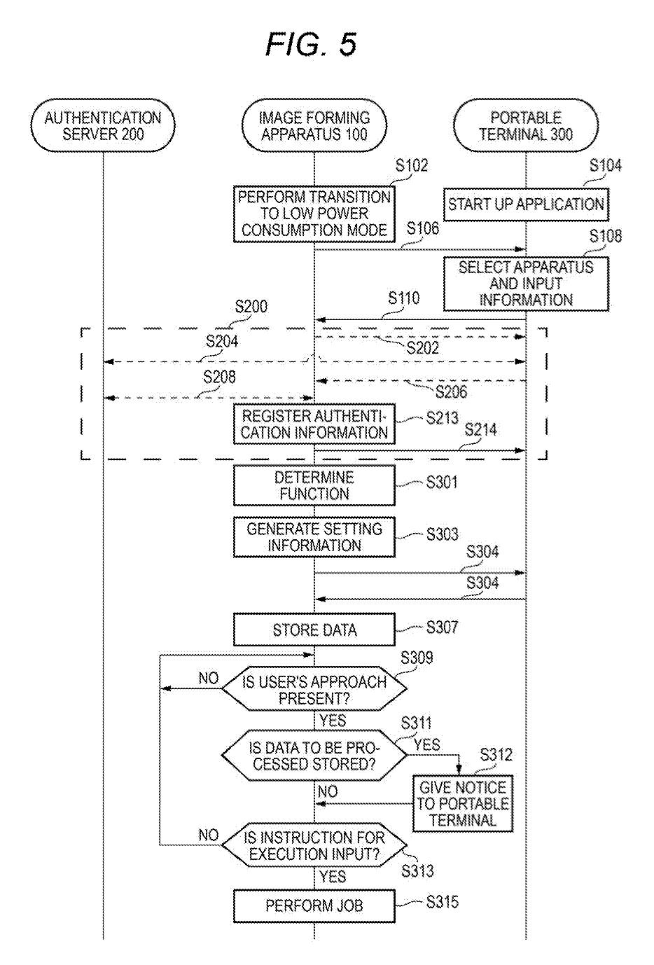

FIG. 5 shows the operation of the information processing system 10. A user operates the portable terminal 300 in advance to start up an application program (S104). Now, it is assumed that the image forming apparatus 100 is in a low power consumption mode (S102). In this state, a beacon is intermittently transmitted from the communication unit 110 (S106). When the portable terminal 300 receives the beacon, information for identifying the image forming apparatus 100 is displayed on a screen of the portable terminal 300. At this time, in a case where beacons are transmitted from the plural image forming apparatuses 100, the portable terminal 300 displays a list of the image forming apparatuses 100 on the input and output section 308 and prompts a user to select with which apparatus communication is performed. The user selects the image forming apparatus 100 and inputs information necessary for authentication (S108).

The information which is input is transmitted to the (selected) image forming apparatus 100 together with an apparatus identifier of the portable terminal 300 (S110). When an apparatus identifier of the portable terminal 300 and a user identifier are received in the communication unit 110, both the identifiers are stored in association with each other. Hereinafter, when the image forming apparatus 100 and the portable terminal 300 communicate with each other, a communication party is specified by including the apparatus identifier in a transmission signal.

Subsequently, the communication unit 110 authenticates a user of the portable terminal 300 (S200). Specifically, any one of the following methods is used.

A first method is a method in which the portable terminal 300 has access to the authentication server 200. Specifically, the URL of the authentication server 200 is transmitted to the portable terminal 300 from the wireless communication section 112 (S202). The portable terminal 300 having received the URL and the like transmits a request for authentication which includes information necessary for authentication such as a user identifier or a password to the authentication server 200 (S204). When the portable terminal 300 acquires authentication information indicating an authentication result and authority information given to the user from the authentication server 200, the portable terminal transmits the acquired pieces of information to the communication unit 110 through the first wireless communication section 321 (S206).

A second method is a method in which the image forming apparatus 100 has access to the authentication server 200 without going through the portable terminal 300. Specifically, the power management section 130 supplies power to the function control section 140 and the wired communication section 128 to validate the function of the wired communication section 128, and then transmits a request for authentication to the authentication server 200 through the wired communication section 128 using information necessary for authentication which is transmitted from the memory 118 to the storage section 150, to thereby acquire an authentication result from the authentication server 200 (S208). At this time, the power management section 130 stops a functional module which is not related to the wired communication section 128. The method results in an increase in power consumption as compared to the first method, but is useful in a case where access to the authentication server 200 from the portable terminal 300 is not permitted or a case where the portable terminal 300 allows only access through a wired LAN.

Which of the first and second methods is used may be determined in advance by the image forming apparatus 100, or may be determined by the image forming apparatus 100 on the basis of an operational state of the wired communication section 128. For example, in a case where the wired communication section 128 operates already in order to perform another processing, the second method is selected.

Meanwhile, the first and second methods may be combined with each other. For example, first, the portable terminal 300 may be made to perform authentication using the first method. In a case where the authentication fails for some reason, the portable terminal 300 may notify the image forming apparatus 100 of the failure of the authentication, and the image forming apparatus 100 may perform the second method when receiving the notification.

In a case where an authentication result acquired from the authentication server 200 indicates that the user is permitted to use the image forming apparatus 100 (in other words, in a case where authentication succeeds), the control section 119 generates authentication information (use ticket) and stores user identification information, identification information of the portable terminal 300, authority information, and a point of time at which authentication information is generated, in the memory 118 in association with each other (S213). Subsequently, the communication unit 110 transmits the authentication information to the portable terminal 300 through the wireless communication section 112 (S214). In the portable terminal 300, the authentication result is displayed.

In a case a failure in authentication such as a case where the authentication result is that the user is not permitted to use the image forming apparatus 100, a screen for prompting the user to input identification information again is displayed. The information which is input again is transmitted to the wireless communication section 112 from the first wireless communication section 321, the processes of S202 to S214 are repeated, and authentication is attempted again.

When the authentication succeeds, the image forming apparatus 100 starts a clocking process, and at least determines which function of the information processing unit 190 is validated, on the basis of authority information (S301). In addition, a timing of validation of each function may be determined as necessary. Specifically, the control section 119 determines to which functional module within the information processing unit 190 power is supplied, on the basis of authority information, and outputs a control signal for commanding the supply of power to only the determined functional module to the power management section 130.

Further, the image forming apparatus 100 generates setting information for realizing the determined function, as necessary (S303). The generated setting information is transmitted to the portable terminal 300 through the wireless communication section 112 together with an identifier of the portable terminal 300 which is stored in the memory 118 (S304). In addition, in a case where processing to be performed after this in accordance with setting information is processing using a functional module within the information processing unit 190, the control section 119 commands the power management section 130 to supply power to the functional module.

For example, in a case where printing is specified as a function, the control section 119 determines to validate the second wireless communication section 127 and the image forming section 122. As a timing of validation (the supply of power), the control section determines to immediately validate the function control section 140 and the second wireless communication section 127, while determines not to validate the image processing; unit 121 until a user's approach is detected.

In addition, information (a mac address and an encryption key of the second wireless communication section 127, and the like) which is necessary for the portable terminal 300 in order to perform an input image data to be printed to the image forming, apparatus 100 through the second wireless communication section 127 and to perform communication through the second wireless communication section 127 is generated as setting information related to the printing process, and is transmitted to the portable terminal 300 through the wireless communication section 112.

When the portable terminal 300 receives the setting information, the portable terminal establishes a wireless communication channel between the second wireless communication section 322 and the second wireless communication section 127 in accordance with the setting information together with an apparatus identifier of the portable terminal 300, and transmits information data to be processed (for example, information indicating a location on a network in which image data to be printed or target data is stored) to the image forming apparatus 100 through the second wireless communication section 127. Meanwhile, the reason for using the second wireless communication section 127 for the transmission of data to be processed instead of using the wireless communication section 112 is because the second wireless communication section 127 is suitable for the transmission and reception of data of a large size due to there being no restriction such as an operation with low power consumption as in the wireless communication section 112. The data to be processed which is acquired from the portable terminal 300 is stored in the storage section 150 in association with an identifier of the portable terminal 300 carried by a user who is a client of this processing (S307). As a result, the user can make the image forming apparatus 100 start processing in accordance with a simple operation such as the pressing of a discharge button of the user interface section 125.

Thereafter, the user moves to an installation location of the image forming apparatus 100 in order to acquire a result of the processing performed by the image forming apparatus 100 (in order to receive discharged paper in a case of printing).

Meanwhile, it is not necessary to notify in advance the image forming apparatus 100 or setting information necessary for processing and data to be processed. That is, the processes of S301 to S307 may be performed together with S311 to be described later. In this case, since it is not necessary to operate the second wireless communication section 127 which is a functional module required to transmit data to be processed in advance, there is the possibility of power consumption in the image forming apparatus 100 being further reduced.

The image forming apparatus 100 monitors the approach of the portable terminal 300 (S309). Specifically, any one or more of the following three methods are used.

A first method is a method in which the image forming apparatus 100 independently detects approach. That is, the detection section 116 determines the presence or absence of a user's approach on the basis of the intensity of a radio wave received front the portable terminal 300 by the wireless communication section 112. Specifically, when the intensity of the radio wave which is calculated by the detection section 116 is set to be equal to or less than a threshold value, the communication unit 110 determines that a distance from the portable terminal 300 is set to be a preset distance (for example, 1 m). The preset distance may be determined by estimating a period of time from the supply of power to a state where processing can be actually performed through a preparation operation (preheating or the like) of the image processing unit 121 and by estimating a timing when a user starts performing input to the image forming apparatus 100.

A second method is a method of making the portable terminal 300 to determine a distance. Specifically, an application program operating in the portable terminal 300 may include a code so as to transmit a predetermined command from the first wireless communication section 321 to the wireless communication section 112 when the intensity of the radio wave which is received front the image forming apparatus 100 is set to be equal to or less than a predetermined value.

In a case where the detection section 116 receives a predetermined signal (command) from the portable terminal 300, it is determined that the detection section 116 has approached the portable terminal 300. According to this method, a predetermined distance (the degree of approach) can be set by a user. Accordingly, a command can be transmitted to the wireless communication section 112 at a timing when the user desires to input an instruction to the image forming apparatus 100 (for example, one second before reaching the image, forming apparatus 100, or the like) to thereby prepare the start-up of the functional unit 120. Even in both the first and second methods, the image processing unit 121 is stopped until the user's approach is detected, and thus a reduction in power consumption is maintained.

In a third method, the power management section 130 supplies power to the short-distance communication section 160 when authentication is completed, and determines a user's approach when receiving a predetermined command from the portable terminal 300 through the short-distance communication section 160. Although power is excessively consumed in the image forming apparatus 100 by the amount of functioning of the short-distance communication section 160, the image processing unit 121 consuming a relatively large amount of power is still stopped, and thus power consumption related to authentication using this method does not much matter. In this case, it is possible to reliably determine that a user can input an instruction for processing through the user interface section 125 right nearby (for example, 10 cm) the image forming apparatus 100 due to a communication range of the short-distance communication section 160. The short-distance communication section 160 outputs a signal indicating the user's approach to the control section 119.

When the control section 119 detects the approach of the portable terminal 300 using any of the above-mentioned methods (S309: YES), the control section determines whether or not data to be processed regarding a user of the detected terminal is stored in the storage section 150. In a case where the data is stored in the storage section, the control section gives notice to the portable terminal 300 through, for example, the second wireless communication section 127 using a predetermined method (S312).

When the portable terminal 300 receives the notice, a message for prompting a user to confirm whether or not the processing may be performed is generated and is displayed on a display section. The reason for prompting the user to perform confirmation is for the purpose of preventing the image forming apparatus 100 from performing processing by itself in spite of now just passing the image forming apparatus 100 sometimes and not being expected to receive printed matter, despite of being expected to receive a processing result in the future and registering processing data in the image forming apparatus 100.

Meanwhile, an application program executed by the portable terminal 300 may realize an operation of assisting a user to specify the image forming apparatus 100 by preferentially displaying (for example, by performing a display at a location easy to see on a screen or with a size easy to see), on the display section of the portable terminal 300, the image forming apparatus 100 which is located closest to the portable terminal 300, the image forming apparatus 100 which is estimated to be a movement destination of the portable terminal 300 on the basis of changes with time in a distance between the image forming apparatus 100 and the portable terminal 300 such as the speed and direction of approach, or the image forming apparatus 100 having a greater tendency to be used by a user, among plural image forming apparatuses 100, in a case where the plural image forming apparatuses 100 can be used at the time of receiving the notice,

When the user inputs an instruction for execution by operating the user interface section 125 or the like in a case of desiring to perform processing (S313: YES), the processing is performed. Specifically, the control section 119 outputs a control signal to the power management section 130 to validate only the functional module (for example, the image forming section 122 in a case of printing), which is determined in S301, in the information processing unit 190. The function control section 140 reads out data to be processed regarding the user from the storage section 150 to make the validated functional module perform the processing (S315). As a result, for example, in a case of printing, paper having an image formed thereon on the basis of image data is discharged from the image forming apparatus 100.

In a case where the user does not desire to perform the processing, the user does not input anything to the: conning apparatus 100 or inputs an instruction for canceling the processing (S313: NO). The control section 119 continues monitoring the user's approach. In a case where approach is detected again, the image forming apparatus 100 similarly gives notice and waits to input an instruction for execution. Alternatively, in a case where the image forming apparatus 100 detects approach for the second time with respect to the same user, the image forming apparatus may perform the processing without giving notice and waiting, for the user's input of an instruction.

Meanwhile, in a case where processing data is not supplied to the image forming apparatus 100 in advance, a user instructs execution through the user interface section 125, the second wireless communication section 127, or the short-distance communication section 160, and inputs data to be processed of designates printing conditions or the like as necessary.

Thereafter, the function control section 140 determines whether the processing has been completed and whether a predetermined period of time has elapsed since the generation of authentication information. In a case where the processing has not been completed for the reason such as a case where the processing has been completed or a case where there is no instruction given from a user, but a predetermined period of time has elapsed since the generation of authentication information, the authentication information regarding the user may be deleted from the storage section 150.

According to the above-described example, even when a portable terminal is not registered in the image forming apparatus 100 in advance, it is possible to make a user use the image forming apparatus 100 by using information registered in an authentication server. In addition, only a necessary functional module can be validated on the basis of a function restriction stored in the authentication server, and thus it is possible to restrict a function that can be permitted by the user.

In addition, even when the authentication of the user using the image forming apparatus 100 fails, the operation of the image processing unit 121 is stopped, and thus a low power consumption state is maintained in the image forming apparatus 100. Even when an authentication process is performed again, power is not excessively consumed.

In addition, even when authentication succeeds, a low power consumption state is maintained until a user approaches the image forming apparatus 100, without immediately returning the image forming apparatus 100 to a normal power consumption state. That is, a low power consumption state is maintained in a case where there is a strong possibility of the user not inputting an instruction for the execution of processing, in a case of a step in which a corresponding time is required until an input is performed, and in a state where the image forming apparatus 100 cannot substantially receive an instruction from the user.

In addition, since the previous authentication has been already completed at the time of inputting an instruction to the image forming apparatus 100, the user never waits until the completion of an authentication process.

In addition, data to be processed is supplied to the image forming apparatus 100 before the execution of processing, and thus the user can acquire a processing result only by inputting a simple instruction.

The invention is not limited to being applied an image forming apparatus, and may be applied to a general information processing apparatus which is not related to the processing of image data insofar as the information processing apparatus includes the communication unit 110. For example, all or a portion of the image processing unit 121 may be omitted. In addition, the communication unit 110, the power management section 130, and the information processing unit 190 may share a portion of functions without being implemented as independent functional modules.

In short, the control device according to the invention may include a wireless communication section, a detection section that detects a user's approach, an acquisition section that acquires authentication information and authority information regarding a user of a terminal when receiving a request from the terminal by the wireless communication section, and a control section that controls a processing section of an information processing apparatus so that a function corresponding to the acquired authority information is realized, when the approach of the user of the terminal is detected by the detection section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A control device comprising:
a wireless communication section;
a detection section that detects a portable terminal's approach;
an acquisition section that acquires authentication information and authority information regarding a user of a portable terminal when receiving a request from the portable terminal by the wireless communication section; and
a control section that controls a processing section of an information processing apparatus so that a function, corresponding to the acquired authority information is realized when the approach of the portable terminal of the user is detected by the detection section.

2. The control device according to claim 1,
wherein the wireless communication section is continuously supplied with power, and
wherein the control section stops the function until the approach is detected.

3. The control device according to claim 2,
wherein the processing section is capable of realizing a plurality of functions related to image formation or transmission and reception of image data.

4. The control device according to claim 3, further comprising:
a storage section, and
a second wireless communication section that operates while being supplied with power greater than the power supplied to the wireless communication section, and
wherein the control section
transmits setting information which is used for the portable terminal to use the function corresponding to the acquired authority information, to the portable terminal through the wireless communication section.
stores information for designating image processing, which is transmitted in accordance with the setting information, in the storage section when the information is acquired from the portable terminal through the second wireless communication section, and
makes the processing section perform image processing based on the information stored in the storage section when detecting the approach.

5. The control device according to claim 1, further comprising:
a communication section that notifies the user that the portable terminal has approached the information processing apparatus,
wherein the control section makes the processing section start processing when receiving an instruction from the user after the notification.

6. The control device according to claim 1,
wherein when the acquisition section receives the request, the acquisition section transmits information used for the portable terminal to have access to an authentication server that manages a registered user and authority information, through the wireless communication section.

7. An image processing apparatus comprising:
a processing section that is capable of realizing a plurality of functions related to image formation or transmission and reception of image data;
a wireless communication section;
a detection section that detects a portable terminal's approach;
an acquisition section that acquires authentication information and authority information regarding a user of a portable terminal when receiving a request from the portable terminal by the wireless communication section; and
a control section that controls the processing section to perform processing based on the request so that a function corresponding to the acquired authority information is realized when the approach of the portable terminal of the user is detected by the detection section.

8. An information processing system comprising:
an authentication server in which a user and authority information regarding the user are registered; and
an image forming apparatus,
wherein the image forming apparatus includes
a processing section that is capable of realizing a plurality of functions related to image formation or transmission and reception of image data,
a wireless communication section,
a detection section that detects a portable terminal's approach,
an acquisition section that acquires authentication information and authority information regarding a user of a portable terminal from the authentication server when receiving a request from the portable terminal by the wireless communication section, and
a control section that controls the processing section to perform processing based on the request so that a function corresponding to the acquired authority information is realized when the approach of the portable terminal of the user is detected,

9. A non-transitory computer readable medium storing a program causing a computer of an information processing apparatus including a processing section, a wireless communication section, and a detection section that detects a portable terminal's approach, to execute:
acquiring authentication information and authority information regarding a user of a portable terminal from an authentication server when a request is received from the portable terminal by the wireless communication section; and
controlling the processing section to perform processing based on the request so that a function corresponding to the acquired authority information is realized when the approach of the portable terminal of the user is detected.

10. An image processing method of an information processing apparatus including a processing section, a wireless communication section, and a detection section that detects a portable terminal's approach, the method comprising:
acquiring authentication information and authority information regarding a user of a portable terminal from an authentication server when a request is received from the portable terminal by the wireless communication section; and
controlling the processing section to perform processing based on the request so that a function corresponding to the acquired authority information is realized when the approach of the portable terminal of the user is detected.

11. The control device according to claim 1, further comprising a plurality of functional modules,
wherein the control section specifies at least one of the plurality of functional modules corresponding to the acquired authority information of the user and supplies the at least one of the plurality of functional modules corresponding to the acquired authority information of the user with power.
